(19) United States
(12) Patent Application Publication
(10) Pub. No.: US 2019/0358872 A1
(43) Pub. Date: Nov. 28, 2019

(54) Method For Producing A Domestic Appliance Component In A Combined Injection Molding Process Involving Thin-Wall Injection Molding And Cascade Injection Molding And Domestic Appliance Component

(71) Applicant: BSH HAUSGERAETE GMBH, MUENCHEN (DE)

(72) Inventors: BRIGITTE FURTH, KITZINGEN (DE); SVEN HOLT, ULM (DE); ALFRED RAAB, HUETTLINGEN (DE); TOBIAS HEISSWOLF, SYRGENSTEIN (DE)

(21) Appl. No.: 16/477,610

(22) PCT Filed: Feb. 9, 2018
(86) PCT No.: PCT/EP2018/053310

§ 371 Date: Jul. 12, 2019

(30) Foreign Application Priority Data
Feb. 24, 2017 (DE) 10 2017 203 052.6

(51) Int. Cl. B29C 45/00

(52) U.S. Cl. CPC B29C 45/0025; B29C 45/27; B29C 45/0046

(57) ABSTRACT

A method for producing a household appliance component for a household appliance includes producing the household appliance component from plastic by injection molding. The injection molding is carried out at least in some phases in a combined injection molding process involving thin-wall injection molding and cascade injection molding. At least a partial region, which is formed as a hollow body, of the household appliance component is produced by the combined injection molding process. A household appliance component is also provided.

The invention relates to a method for producing a household appliance component for a household appliance, wherein the household appliance component is produced from plastic. The invention also relates to a household appliance component.

Plastic components as household appliance components for a household appliance are extensively known. In particular for household refrigeration appliances in the form of a refrigerator or freezer or a refrigerator-freezer combination, such household appliance components are, for example, known as door racks on the inside of a door. Also known are large components, such as an inner lining or inner door of the overall door that is arranged swivel-mounted on a housing for sealing a receiving space for foodstuffs. Such household appliances are relatively large and, with present forming designs, in particular produced by thermoforming. To this end, previously extruded semi-finished products in the form of plates or coils are used.

Flat household appliance components can also be produced by means of conventional injection molding. However, the lower wall thickness values of these components are limited since a minimum wall thickness is required for complete filling of the injection mold. In particular in the case of larger components, the wall thicknesses are significantly more than 1.5 mm. With such procedures, the melt is introduced into the injection mold via a single injection point. In particular, when large household appliance components are to be produced that are also embodied as flat or planar over large regions, the lower wall thickness is also limited with conventional production processes. This is also due to the fact that the clamping forces for the injection mold are very high. In addition, this relatively high wall thickness results in a very long melt cooling time.

Therefore, with current manufacturing techniques, particularly in the case of large components and also for economic reasons, thermoforming is preferred over injection molding.

It is the object of the present invention to provide a method by means of which specific geometric regions of a household appliance component can be produced in an improved manner by injection molding. In particular, it is also an object to provide a corresponding household appliance component.

This object is achieved by a method and a household appliance component according to the independent claims.

One aspect of the invention relates to a method for producing a household appliance component for a household appliance, wherein this household appliance component is produced completely from plastic by injection molding. The injection molding is carried out at least in some phases as a combined injection molding process, wherein to this end thin-wall injection molding and cascade injection molding is carried out. With the combined injection molding process, at least one partial region formed as a hollow body of the household appliance component is produced. A method of this kind enables specific geometric regions of a household appliance component to be produced with a precise shape and also in fine detail while still retaining stability and mechanical load-bearing capacity. The combination of individual injection molding techniques also enables very thin wall thicknesses in very complex-shaped geometric regions in the form of hollow bodies. This also enables the household appliance component to be created with a reduced weight.

Hence, with a method of this kind, the household appliance component as a whole, and in particular the hollow body, is formed as thin-walled and the introduction of the melt is enabled by the plurality of injection points required for cascade injection molding. By means of this specific combination, it is achieved in a particularly novel and advantageous manner that locking forces of the injection mold can be kept relatively low during the production of the household appliance component. This in particular, since, at some sites, the injected melt has already solidified and, at other sites, the melt has not yet been injected or has only just been injected. This also means that it is possible to use injection molds that can also be used with a previously conventional technique, which was limited. Reducing the wall thickness of the household appliance component results, on the one hand, in a reduction of the locking forces required. However, since, with the use of only one injection point with a thin-walled embodiment of this kind, drawbacks again occur during the injection of the melt and in the case of relatively large components, due to undesirable premature curing at one site and insufficient delivery of the melt at all sites, here once again a relatively high injection pressure would be required, which in turn results in increased locking forces for the injection mold. In addition, an embodiment of this kind could be considered to have the drawback that, on cooling and hence a certain shrinkage of the plastic, subsequent injection for replenishing would be required only conditionally and/or again at high pressure, thus again resulting in high locking forces.

The invention also resolves this problem with cascade injection molding, and hence a plurality of injection points, under the condition of thin-wall injection molding. The plurality of injection points can prevent premature but nevertheless very rapid curing at specific sites in the melt thus also enabling relative uniform introduction of the melt and hence achieving curing on the one hand and delivery of the melt to all sites in the injection mold for complete final shaping of the household appliance component to be created. This is of particular advantage in the creation of hollow bodies as partial regions of the household appliance component. The plurality of injection points then also further helps to achieve the reduction of the required locking forces of the injection mold already associated with thin-walled production. This novel procedure in the form of the combination of two quite specific injection molding procedures then also enables the use of injection molds and machines that are advantageous in respect of the economic production of the household appliance component and in relation to which lower locking forces suffice. Since, in view of their respective maximum locking force, particularly these machines and injection molds are a significant cost factor in manufacturing plants, a significant advantage can be achieved by the invention in this context. Hence, in particular compared to the aforementioned injection molding manufacturing of such larger household appliance components, which, however, can then only be produced with thick walls, it is not necessary to use other injection molds that can be exposed to higher locking forces; on the contrary, it is also possible to use these conventional appliances and machines. The invention can then also enable the primary injection of melt in injection points and simultaneously a replenishing injection of melt in injection points via which the melt which was previously primarily injected there has already cooled in the injection mold.

The invention is particularly advantageous in the context of relatively large household appliance components which have large portions on planar or substantially planar surface regions and additionally have complex-shaped hollow bodies. Since, as explained in the introduction, conventional injection molding is in particular not economical with such geometrically specific household appliance components, as is the case, for example, with inner linings or inner doors of a door of a household refrigerator comprising hollow bodies, this is counteracted with the invention.

Thin-wall injection molding is preferably carried out during the injection molding process with a characteristic parameter relating to the wall thickness-flow length ratio of greater than 1:200. This thin-wall injection molding is particularly advantageously carried out with a wall thickness-flow length ratio of between greater than 1:200 and greater than 1:300. Such a value or value interval of the characterizing parameter enables the above-named advantages to be achieved to a large extent. It is particularly with the components that are then to be produced larger with large surface regions that it is then possible also to attain a preferred degree of wall thinness with simultaneous sufficient curing of the melt while retaining sufficient flow front speeds. As a result, the hollow body of the household appliance component is created dimensionally accurately and with thin walls, wherein, in particular also in the cooling phase, which is then in turn shorter due to the thin walls, the locking forces can be kept relatively low.

The walls bounding the hollow body are preferably produced by the combined injection molding process with thin-wall injection molding and cascade injection molding with a wall thickness of less than 1.5 mm, in particular between 0.6 mm and 1 mm.

In particular, the hollow body is produced as an elongate bar or runner. With the previous method, particularly this shaping in conjunction with the hollow embodiment can only be created in a very globate and dimensionally imprecise manner. Since such geometric regions are very important, for example, in the case of inner linings of a door of a household refrigerator since they are provided to receive further components, such as, for example, door racks, these bars must also have a very stable but nevertheless compact construction design in order to not waste space. This is very advantageously enabled particularly by means of the combined injection molding process.

Two side walls of the bar shape of the hollow body are preferably produced at their free end by the combined injection molding process with thin-wall injection molding and cascade injection molding with a distance smaller than or equal to 14 mm, in particular between 11 mm and 14 mm. This enables the formation of very narrow hollow bodies requiring little width space yet which still have sufficient mechanical load-bearing capacity.

Two side walls of the bar shape of the hollow body are preferably produced at their ends opening onto a base wall of the groove shape by the combined injection molding process with thin-wall injection molding and cascade injection molding with a distance smaller than or equal to 7 mm, in particular between 5 mm and 6.5 mm. Particularly the base of groove, and hence in cross section perpendicular to the longitudinal axis of the hollow body, this hollow body can be produced as very narrow and yet also stable at particularly these sites as a result of which a hollow body with a greatly reduced width is provided.

In particular, a transition between an outer side of a side wall and an outer side of an outer side of a further partial region of the household appliance component opening onto the free end of the side wall is produced by the combined injection molding process with thin-wall injection molding and cascade injection molding with a radius smaller than or equal to 1.5 mm, in particular between 1 mm and 1.5 mm. This enables very sharp and locally very limited transitional regions to be produced thus enabling undesirable globate bulges or dimensional imprecisions to be avoided.

In particular, a front wall opening onto a base wall of the hollow body is formed in the direction of a longitudinal axis of the hollow body at an end of the hollow body, wherein a transition is produced between an outer side of the front wall and an outer side of the base wall by the combined injection molding process with thin-wall injection molding and cascade injection molding with a radius smaller than or equal to 2.5 mm, in particular between 1.5 mm and 2.0 mm. Additionally or alternatively, to this end a transition between an outer side of the front wall and an outer side of an outer side of a further partial region of the household appliance component opening onto the free end of the front wall is produced by the combined injection molding process with thin-wall injection molding and cascade injection molding with a radius smaller than or equal to 1.0 mm, in particular between 0.4 mm and 1.0 mm. Such small radii cause the hollow body to be produced as very dimensionally precise and as a result particularly edge regions can be created as very narrow or sharp and in fine detail.

Preferably, on an outer side of a side wall of the hollow body, a receiving structure facing away from the hollow region of the hollow body, in particular a holding lug, is produced by the combined injection molding process with thin-wall injection molding and cascade injection molding. This enables an integrated additional element to be created on the hollow body to which it is easy to attach a further separate component. For example, a door rack of a household refrigeration appliance can be attached on this lug. It is also possible for this lug to be created by the combined injection molding process as very dimensionally precise and in fine detail yet with high mechanical stability.

Preferably, in the hollow region of the hollow body, at least one reinforcing rib is produced by the combined injection molding process with thin-wall injection molding and cascade injection molding. This enables the interior of the hollow body to be reinforced, wherein particularly the combined injection molding process enables a relatively thin rib to be produced in a locally precise manner in this difficult-to-access site.

None of these aspects can be realized with conventional methods, such as thermoforming or normal injection molding, since these hollow bodies cannot be created or can only be created with very high wall thicknesses and dimensional imprecisions so that they are particularly unsuitable for specific applications, for example as components of a door of a household refrigeration appliance. With the conventional method, the components are relatively heavy and/or not sufficiently stable at the specific geometric regions deviating from surface regions (substantially planar regions). Narrow geometric regions, which are in particular hollow bodies, cannot be produced here. Narrow is understood to mean a specific hollow-body width: hollow-body height ratio (in each case viewed perpendicular to a longitudinal axis of the hollow body). Narrow is understood to be hollow bodies with such a ratio of 1:4 or less, i.e. for example 1:5 etc. In the case of conventional methods, such as those cited, folds, and hence quite specific dimensional imprecisions, which are also undesirable, occur during the creation of hollow bodies.

In addition, with the cited conventional methods, the stability of narrow bars is lower than that of normal bars. The reason for this is, on the one hand, the laws of mechanics. However, the topic of complete foam incorporation is very important. In the case of household refrigeration appliances, this means that an insulating foam is applied to the household appliance component in particular in the region of the hollow body. In the case of an inner door of a refrigeration appliance, the strength of the bar is mainly defined by the foam in the interior of the bar. In the case of very narrow bars, the foam might not completely fill the bar and the bar remains partially empty. In the case of conventional household appliance components, the strength is not sufficient with partial filling. Therefore, the lowest width of the bar is restricted by the foamability as a result of which it is not possible to produce a narrow component, in particular without other restrictions.

It is preferably provided that, viewed in the direction of the longitudinal axis of the household appliance component, for cascade injection molding, at least one injection point of the plurality of injection points is specified in the center. Via this at least one central injection point, an injection of a melt of the plastic material into an injection mold is commenced, at least at times, before the injection of the melt into at least one other injection point specified as off-center when viewed along the longitudinal axis of the household appliance component. This is also a very advantageous procedure, on the one hand, with regard to the location of the injection points, and, on the other, with regard to the sequence in which the melt is injected into which specified injection points and when. It is particularly when thin walls are created that these specific processes cause the aforementioned advantages to occur in a further improved form.

It can be provided that the at least one central injection point is also positioned centrally in the width-wise direction, which is oriented perpendicular to the longitudinal axis of the household appliance component. As a result, this then one central injection point specifies a symmetrical location that also enables a symmetrical distribution of the melt in the direction of the longitudinal axis and in the width-wise direction of the household appliance component.

It is in particular provided that the at least one central injection point and the at least one injection point specified as off-center lie on a common straight line corresponding to the longitudinal axis or extending parallel to this longitudinal axis.

Preferably, a time of the commencement of an injection into an injection point specified as off-center is specified in dependence on the type of melt to be injected and/or in dependence on the type of melt injected into the at least one central injection point and/or a distance measured along the longitudinal axis between the at least one central injection point and the off-center injection point and/or the diameter of the at least one central injection point and/or the diameter of the off-center injection point and/or the number of off-center injection points, which on the same longitudinal location along the longitudinal axis to this off-center injection point, and/or the injection pressure of the melt into the at least one first central injection point and/or into the injection pressure provided in the off-center injection point and/or the amount of melt injected into the at least one central injection point and/or the amount of melt provided to be injected into the off-center injection point melt and/or a duration of an injection of a melt via the central injection point.

Additionally or alternatively, to this end, it can also be provided that a time of the end of an injection into an off-center specified injection point is specified in dependence on the type of melt to be injected and/or in dependence on the type of melt injected into the at least one central injection point and/or a distance measured along the longitudinal axis between the at least one central injection point and the off-center injection point and/or the diameter of the at least one central injection point and/or the diameter of the off-center injection point and/or the number of off-center injection points, which on the same longitudinal location along the longitudinal axis to this off-center injection point, and/or the injection pressure of the melt in the at least one first central injection point and/or in the injection pressure provided in the off-center injection point and/or the amount of melt injected into the at least one central injection point melt and/or the amount of melt provided to be injected into the off-center injection point melt and/or a duration of an injection of a melt via the central injection point.

As a result, cascade injection molding is performed very precisely in respect of the melt to be introduced and the injection points so that the speed of the flow fronts of the melt and is well matched to the desired cooling at specific sites and as a result, even with the most diverse household appliance components, in particular with large planar or substantially planar surface regions in relation to the overall size of the household appliance component, rapid and dimensionally precise manufacturing with relatively small locking forces of the injection mold is enabled.

This flexibility with regard to the consideration of the most diverse of parameters, which can be considered in respect of the time of the commencement of the injection at an off-center specified injection point and/or in respect of the time of an end of an injection of the melt into this off-center specified injection point produces highly individualized matching scenarios for the production of a household appliance component. This enables extremely finely adjusted and hence precise setting of at least one of these times with regard to the shape and in particular the size of the household appliance component. Hence, advantageously account is taken of the production precision of the household appliance component with regard to homogeneous wall thickness. Here, it is possible with regard to requirements to enable the lowest possible locking forces for the injection mold and hence in particular to use conventional locking forces and corresponding injection molds to control an individually matched injection process. This enables undesirable high locking forces or peak locking forces to be avoided.

The fine adjustment of the injection process and hence the corresponding control via a control unit in the manufacturing plant enables the aforementioned advantageous embodiment also significantly to reduce a possible scrap rate for household appliance components.

In particular, at least one first off-center injection point is specified at the at least one central injection point in a first direction along the longitudinal axis at and at least one second, off-center injection point is specified based on the at least one central injection point in a second direction opposite to the first direction along the longitudinal axis of the household appliance component. The injection of a melt into the at least one first and the at least one second off-center injection point is performed, at least at times, in particular completely, simultaneously with the injection of the melt into the at least one central injection point. As a result, the process of filling the injection mold with the melt is performed in two directions extending opposite to the longitudinal axis, in particular synchronously. Therefore, manufacturing progress takes places out in two opposite directions simultaneously so that, viewed in the direction of the longitudinal axis, the melt material is also brought simultaneously to the respective opposite ends of the household appliance component to be produced so that the introduction process and the in each case successive subsequent curing takes place in each case at sites on opposite side of the center when viewed in the direction of the longitudinal axis, also synchronously. This again further helps to achieve the aforementioned advantages since the flow fronts extend in two opposite directions and, due to the introduction this direction at these sites and the curing that then takes place in each case, here once again the locking forces of the injection mold can be kept as low as possible.

In one advantageous embodiment, for the cascade injection molding, at least two injection points of the plurality of injection points are specified at the same longitudinal location and at opposite sides of the longitudinal axis and hence perpendicular to the longitudinal axis when viewed in the direction of the longitudinal axis of the household appliance component, wherein a melt of the plastic material is injected simultaneously into an injection mold via these at least two injection points lying in the same location along the longitudinal axis simultaneously. As a result, an improvement in the production is achieved and the aforementioned advantages are also obtained with regard to the width of the household appliance component measured perpendicular to the longitudinal axis.

Particularly with wider household appliance components, in particular in respect of wider surface regions, this plurality of injection points in the width-wise direction can again improve the introduction of the melt material, the curing of the melt material and the necessary subsequent injection and, in this respect then with the smallest possible and minimized locking forces of the injection mold.

It is preferably provided that, due to the combination of thin-wall injection molding and cascade injection molding, which is carried out simultaneously, the household appliance component, in particular at least in the region of the hollow body, and hence also the hollow body itself, is produced with a wall thickness of less than 1.5 mm and particularly advantageously between 0.6 mm and 1 mm. With conventional injection molding options, at best minimum wall thicknesses of 2.5 mm are produced. Particularly in the case of very large household appliance components with in particular relatively large, planar surface regions or substantially planar surface regions, the invention or advantageous embodiments thereof can achieve a significant wall thickness reduction and hence in the first place a thin-walled region is formed, wherein here the walls are very thin. Particularly with such specific household appliance components, with the then plurality of injection points with cascade injection molding, this has a particularly advantageous effect on the necessary locking forces of the injection mold, not only during the primary injection of the melt, but also during the curing or cooling and in particular also during the possible subsequent injection due to shrinkage of the cured melt.

This advantageous embodiment not only enables cooling to take place more quickly due to the thin walls, thus also enabling subsequent injection to be performed promptly, but, also due to the reduced cooling time, the time of the locking process of the injection mold can be reduced, which in turn is advantageous in respect of the requirements for the injection mold also with regard to energy consumption for manufacture so the manufacturing process can also be performed in a more energy-efficient way.

It is preferably provided that at least four injection points are specified for cascade injection molding. Depending upon the embodiment of the household appliance component to be manufactured and in particular the size thereof, preferably the size of the planar or substantially planar surface region, the number of injection points can also be specified as greater than 10, in particular greater than 30, in particular greater than 50, in particular greater than 70, in particular greater than 90 and possibly also up to 100 injection points or more.

In one particularly advantageous embodiment, a trough-shaped household appliance component is produced as a household appliance component. In particular, in this context, an inner lining or an inner door of a door of a household appliance formed to close a receiving space for foodstuffs is produced with at least one hollow body. Hence, an improved method can be provided with regard to the manufacturing sequence particularly for these specific household appliance components. In respect of improvements, reference is made once again to the advantages cited above.

In an advantageous way, a trough base of the trough-shaped household appliance component is produced in one piece with the hollow body with a quadrangular planar region with a first side length, in particular a width, of at least 30 cm and/or second side length, in particular height, of at least 25 cm by the combined injection molding process. Such household appliance components with hence relatively large surface regions can be achieved by the combined injection molding process in respect of the reduction of the duration of the production process in particular the cooling time of the melt, in respect of the requirements for the locking forces of the injection mold and also with regard to the contour acuity and complete introduction of melt including into marginal regions with lower injection pressures of the melt in this respect.

Injection points for the cascade injection molding are preferably specified in dependence on the size of the trough-shaped household appliance component to be produced. In particular, injection points for this cascade injection molding are specified in dependence on the size of the planar or substantially planar surface region of a trough base of the household appliance component. Since particularly these geometrically specific special regions of such a household appliance component are essential in respect of the injection sites, injection pressures, the distribution of the melt with regard to the possibly too fast or too slow, and hence undesirable, curing, and the possibly necessary increase in the locking forces of the injection mold, it is possible to react thereto in a manner extremely dependent upon the situation and to counteract it by the advantageous embodiment, here again the thin walls on the one hand and the targeted local injection points on the other.

In a further advantageous embodiment, it is provided that the number of injection points along a longitudinal axis of the household appliance component and/or the location of the injection points is specified in dependence on the size of the trough-shaped household appliance component to be produced. Here, this specification is again specified in dependence on the size of the planar or at least substantially planar surface region of a trough base of the household appliance component. The advantages described above for the other embodiment apply here correspondingly.

In a further advantageous embodiment, it is provided that the number of injection points are specified in pairs and on opposite sides of a longitudinal axis and hence in the width-wise direction to the longitudinal axis of the trough-shaped household appliance component and the number of these injection point pairs are specified in dependence on the size of the trough-shaped household appliance component to be produced. With this embodiment, this number of injection point pairs is specified in dependence on the size of the planar or substantially planar surface region of a trough base of the household appliance component. Here, once again the aforementioned advantages apply.

In one advantageous embodiment, a locking force for locking an injection mold during the injection molding of the household appliance component with the combination and hence the simultaneous performance of thin-wall injection molding and cascade injection molding is correspondingly limited to a value of smaller than or equal to a weight of 1700 tonnes. In particular, this locking force is correspondingly restricted to a value smaller than or equal to a weight of 1600 tonnes. This is a very advantageous embodiment since it is hence possible to use injection molds with which said specified locking forces can then also in particular be provided as maximum locking forces. As a result, the injection molds used for production can be much smaller and also less expensive to procure and operate than injection molds that enable much higher locking forces. Since, here, particularly said costs for injection molds with locking forces increase not only linearly but more greatly in relation thereto, such drawbacks are also significantly incorporated in the production costs and hence the possibility of implementation in a manufacturing method with such injection molds. Particularly due to the invention or an advantageous embodiment thereof, it is now also possible to use much less expensive injection molds with lower maximum locking forces and still produce the above-named, and in particular very large, household appliance components characterized by large planar or substantially planar surface regions. This was not possible with the previous injection molding technique. Particularly in the case of specific, in particular trough-shaped, household appliance components named in this respect, the combination of the thin-wall injection molding technique with the cascade injection technique enables locking forces to be reduced such that conventional injection molding machines and, in addition, even those with lower locking forces can be used.

This invention also makes it possible that these low locking forces, in particular smaller than or equal to a value corresponding to a weight of 1700 tonnes are sufficient not only for the primary melt injection process, but also for locking during cooling and also the possible necessary subsequent injection of the melt due to shrinkage on cooling.

In particular, as mentioned above, an inner lining or an inner door of a door for a household refrigeration appliance is produced as a household appliance component. Due to their trough shape, these usually have a relatively large planar or substantially planar surface region in the form of the trough base so that here the problems mentioned in the introduction come particularly into play; on the other hand, the solution according to the invention now enables advantageous production of these specific household appliance components as well and, to be precise, within the context of injection molding.

The invention furthermore also relates to a household appliance component, which is produced according to the invention or an advantageous embodiment thereof. The method according to the invention enables a greatly reduced wall thickness, namely a thin wall, with these specific household appliance components particularly in the region of the hollow body while still enabling sufficient complete filling with the melt and a sufficient holding pressure effect with rapid production. Particularly for household appliance components to be produced with which the maximum flow paths of the melt to be introduced are more than 200 mm, a wall thickness of much less than 1.5 mm can now be enabled. If, for example, a very free-flowing plastic is used as the melt, a distance of injection points viewed along the longitudinal axis of the household appliance component and/or viewed perpendicular to the longitudinal axis and hence in the width-wise direction of the household refrigerator can be greater. As a result, the required number of injection points is reduced based on a fixed component size.

Due to simultaneous or also combined cascade injection molding, even with this thin-walled technique, the filling of the injection mold with the melt does not take place simultaneously via all injection points but in fact in succession, and hence cascaded. Herein, the individual cascade stages are called sequence zones.

As addressed above, for the introduction of the melt into the injection mold and hence the filling process, it is possible to perform the most diverse, different and very situation-related activations and deactivations of the individual sequence zones specified for the household appliance component to be produced in each case. The sequence zones can, for example, also be controlled by means of the injection volume, the injection stroke, the injection time, the injection pressure or the position of the flow front of the melt in the cavity or the injection mold.

In one advantageous embodiment, the position of the flow front in the injection mold is determined, for example, by measuring the local internal mold pressure or the local mold wall temperature.

To this end, a sensor or corresponding sensors can be provided on the surface of the injection mold. If, for example, a specified temperature threshold is then exceeded, it is possible to draw conclusions regarding the precise location of the flow front within the injection mold. The invention renders the achievable pure wall thicknesses, and hence the thin-walled embodiment, independent of the size of the household appliance component to be manufactured. In addition, it can also be provided that surfaces of the household appliance component to be produced can be individually structured completely or at least in regions, wherein here, for example, different degrees of gloss or matt surfaces can be created. A sensor can also be integrated in the wall of the injection mold and hence be completely surrounded by the material of the wall.

It is preferably provided that the location of a flow front is determined in dependence on one or more injection times at one or more injection points.

The household appliance component is preferably produced from PP (polypropylene), at least in regions, in particular completely from PP. With thin walls and the plurality of injection points, particularly this material with its flow properties—PP is free-flowing—enables the named advantages particularly to be fulfilled, in particular when large household appliance components are created with large planar or substantially planar surface regions.

In a further, very advantageous embodiment, it can also be provided that the household appliance component is produced not from only one single plastic material, but is manufactured from at least two different plastic materials. An at least two-component household appliance component of this kind can be created very precisely from the locally required difference plastic materials in each case particularly with regard to the injection points.

The method according to the invention or an advantageous embodiment thereof enables the creation of not only geometric household appliance components, but also of household appliance components with a wide diversity of sizes. For example, it is possible to create small thin-walled household appliance components with relatively large and planar or substantially planar surface regions and hollow bodies with specific shapes. For example, these household appliance components can be produced with a height of up to 30 cm, a width of up to 15 cm and a wall thickness of less than 1 mm, in particular between 0.5 mm and 0.9 mm, in particular 0.8 mm. However, in this respect, it is also possible for even larger household appliance components to be produced, which can be formed with a height of 180 cm or greater, with a width of between 60 cm and 90 cm, in particular 80 cm, and in particular a wall thickness of less than 1 mm, preferably between 0.5 mm and 0.9 mm, in particular 0.8 mm. However, any intermediate values of the stated heights and/or widths and/or wall thicknesses are possible as further embodiments alone or in combination.

As mentioned above, the invention enables a significant reduction to be achieved in the clamping forces or locking forces of the injection molding machine or the injection mold than would otherwise be required for such components. In the case of usual conventional injection molding techniques, the filling pressure or holding pressure act simultaneously on the entire projected surface of the component to be produced. Therefore, the production of large components by means of conventional injection molding requires injection molding machines with very high clamping forces. The method according to the invention enables the required clamping force to be reduced by up to 80 percent with the same component size, in particular in the case of trough-like household appliance components with a very large planar or substantially planar surface region compared to the remaining region of the household appliance component.

Due to the additionally resulting only small wall thicknesses and hence the thin walls, the component regions filled first solidify as early as during the filling process. This is a significant advantage. At the time of the complete filling of the injection mold with the melt, larger regions of the household appliance component to be produced have already solidified. However, the internal pressures only act only in the regions in which the melt is still present and hence the liquid plastic material is still available. Hence, the internal pressure only acts on a partial region of the overall projected component surface. To prevent a collapse of the component or individual component regions due to heat shrinkage of the plastic during cooling, in conventional injection molding, the component to be produced is exposed to holding pressure after the complete filling.

In the case of the invention with combined thin-wall injection molding and cascade injection molding, this holding pressure is ineffective for component regions that have already solidified after complete filling. The holding pressure for these component regions is guaranteed by the filling pressure as early as the component filling; this a further significant advantage of the invention. In this case, the filling pressure, on the one hand, acts so-to-speak forward during the filling and hence in the direction of the propagating flow front and as a holding pressure so-to-speak rearward. The significant reduction in the clamping forces is only provided by the combination of a thin-wall technique and cascade injection molding for flat component geometries of household appliance components to be produced.

The creation of thin walls drastically reduces the cooling times and the flat component geometries in conjunction with the time-staggered injection points enable a simultaneous filling effect and a holding pressure effect. Therefore, it is possible during the manufacturing method, and hence at times at which not all the plastic material has been introduced, for the primary introduction of the melt still to be carried at certain sites via certain injection points and simultaneously to apply a holding pressure at other sites, at which the previously introduced melt has already cooled down.

In addition, the invention also enables the basic construction of the injection mold to be used for a family of appliance components, which in this context are identical in shape and therefore only differ in their size. This is because, with corresponding household appliance components with different dimensions, the number of injection points of the injection mold that are used can be freely selected. For example, it is also possible, for a household appliance component of this family that is smaller in this respect to use only half the available injection points. For a household appliance component of a component family that is comparatively larger, it is then possible to use and operate a plurality of injection points in this standard mold. Hence, it is conceivable that only one injection mold with plurality of exchangeable disks is required for a component family instead of a plurality of completely separate injection molds.

Hence, in addition to the technical advantages, the invention also enables the unit costs to be reduced. In addition, it also provides a higher component quality and a higher degree of constructive freedom including a plurality of design options for additional elements. For example, in respect of higher degrees of freedom, individual constructive features can be designed more simply and in finer detail and in more shape variants than is possible with thermoforming. For example, integrated elevated raised lugs can be designed in finer detail. In this context, it can for example be provided that the lug is no longer realized as a complete elevated hump-like structure but the elevation is only realized by a fine-detail circumferential edge or a circumferential contour line. This can then be created with the same stability and with at least the same dimensional precision.

The invention also relates to a household refrigeration appliance with a household appliance component produced according to the method.

The terms “up”, “down”, “front”, “rear, “horizontal”, “vertical”, “depth direction”, “width-wise direction”, “height-wise direction” refer to the positions and orientations with use as specified and the arrangement as specified of the appliance and with an observer standing in front of the appliance looking in the direction of the appliance.

Further features of the features of the invention can be derived from the claims, the figures and the description of the figures. The features and feature combinations mentioned in the description and the following features and feature combinations mentioned in the description of the figures and/or in the figures are also usable not only in the combination specified in each case but also in other combinations without departing from the scope of the invention. Hence, embodiments that are not explicitly shown or explained but can be derived from and can be generated by separate feature combinations from the explained embodiments should also be considered to be included and disclosed. Hence, embodiments and feature combinations that do not have all the features of an originally formulated dependent claim should also be considered to be disclosed. Moreover, embodiments and feature combinations, in particular from the above-described embodiments, that extend beyond or deviate from the feature combinations described in the back-references in the claims should also be considered to be disclosed.

Exemplary embodiments of the invention are described below with reference to schematic drawings, which show:

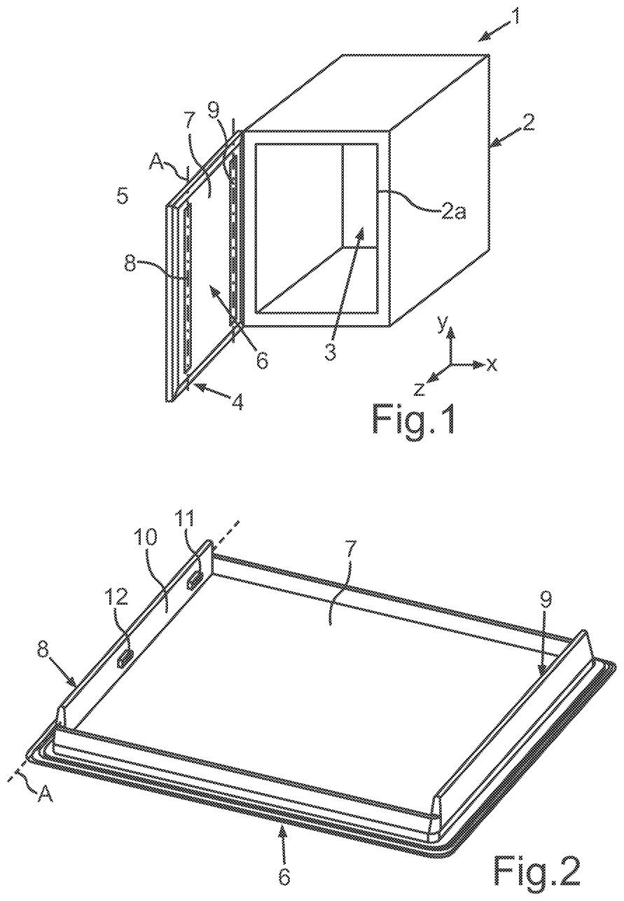

FIG. 1 a perspective view of an exemplary embodiment of a household appliance according to the invention with an embodiment of a household appliance component according to the invention;

FIG. 2 a perspective view of an exemplary embodiment of a household appliance component;

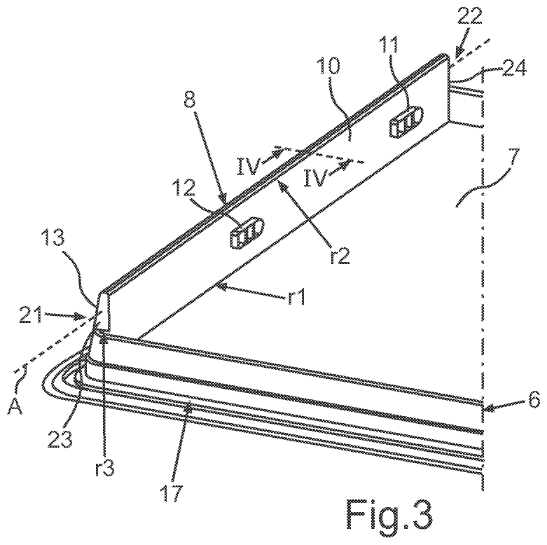

FIG. 3 a perspective view of a partial region of FIG. 2;

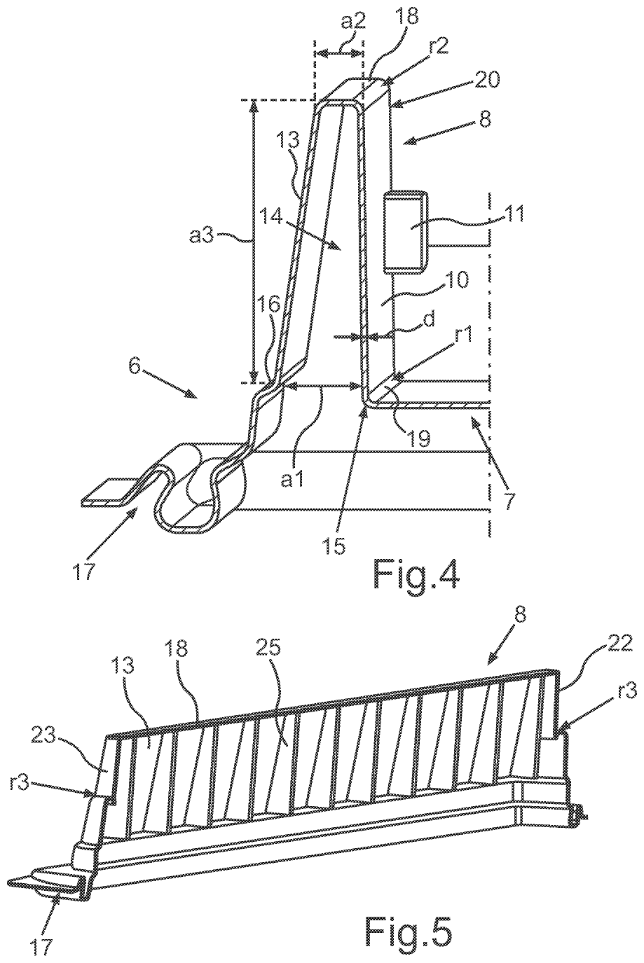

FIG. 4 a sectional view of a partial region of the household appliance component according to FIG. 2 and FIG. 3 in the region of a hollow body of the household appliance component; and

FIG. 5 a further sectional view of the household appliance component in the region of the hollow body.

In the figures, elements that are the same or have the same functions are given the same reference characters.

FIG. 1 shows a perspective simplified view of a household appliance 1, which is a household refrigeration appliance and can, for example, be a refrigerator or a freezer or a combined refrigerator-freezer. The household appliance 1 is formed to receive foodstuffs and has a housing 2 in which a corresponding receiving space 3 is formed. The receiving space 3 is bounded by walls of an inner container 2a. At the front, the receiving space 3 can be sealed by a door 4 that is arranged swivel-mounted on the housing 2. The door 4 has a multi-part structure and has an outer door 5 and an inner door, which represents an inner lining 6. The inner lining 6 is a visible component of the door 4 and hence an external component. When the door 4 is closed, this inner lining 6 faces the receiving space 3. This inner lining 6 is formed in one piece from plastic and represents a trough-like household appliance component. Inserted between the outer door 5 and the inner lining 6, at least in regions, is a thermally insulating material, in particular an insulating foam, which is present but not visible as it is covered by the outer door 5 and the inner lining 6.

In addition, other components, for example at least one door rack, which is not shown, can also be arranged on the inner lining 6.

The household appliance component in the form of the trough-like inner lining 6 is produced by injection molding, wherein, during this injection molding, at least at times during the manufacturing process, a combined injection molding process is carried out. To this end, at least in some phases, thin-wall injection molding and cascade injection molding are carried out. Herein, thin-wall injection molding is in particular carried out with a wall thickness-flow length ratio of greater than 1:200, in particular between greater than 1:200 and 1:300.

As can be identified from the schematic view in FIG. 1 the dimensions of the household appliance component predominantly involve a planar or substantially planar surface planar region, which here is formed by a trough base 7 of a trough-shaped base part of the inner lining 6.

In the exemplary embodiment shown, preferably two elongate bars 8 and 9 that are oriented as raised from the planar surface are arranged on this trough base 7. The bars 8, 9 are formed on an outer side facing away from the trough interior and hence extend facing away from this trough interior. These two bars 8 and 9 are in particular formed in straight lines and the arrangement on the door 4 is orientated in the height-wise direction. The bars 8 and 9 are co-produced in one piece on the inner lining 6 during this combined injection molding process. When the door 4 is closed, these two bars 8 and 9 extend in the direction of the receiving space 3. They can be formed substantially over the entire height of the inner lining 6 or also only in partial sections thereof. The two bars 8 and 9 are formed parallel to one another and formed on opposite side regions of the inner lining 6. The bars 8 and 9 are formed as hollow toward the side facing away from the receiving space 3 and hence with the embodiment of the door 4 facing the outer door 5. Hence, the hollow bodies in this respect in the form of the bars 8 and 9 are also formed open toward this outer door 5.

Therefore, the bars 8 and 9 represent groove-shaped hollow bodies and are correspondingly produced by the combined injection molding process.

In particular, the bars 8 and 9, preferably the entire inner lining 6, are produced by injection molding, wherein here, at least in some phases, a combined injection molding process is carried out as a thin-wall injection molding and cascade injection molding and with this combined injection molding process at least one partial region formed as a hollow body of the household appliance component is produced and hence the bars 8 and 9 of the inner lining 6 are produced correspondingly. Hence, the combined injection molding process includes the two different individual injection molding techniques, namely thin-wall injection molding and cascade injection molding.

These elevated and shape-specific bars 8 and 9 can then form receivers for further separate components, which can be attached to the inner lining 6. In particular, a door rack can be fastened to these bars 8 and 9. Another type of attachment of a door rack, for example on the actual trough base 7 is then not provided. These bars 8 and 9 provide a simple and yet mechanically stable fastening option for such other types of components.

As can be identified in the enlarged view of the inner lining 6 in FIG. 2, to this end it can be provided that at least one additional structure or additional element is integrally formed on a boundary wall 10 of a bar 8 in order provide a more advantageous fastening of a further component, in particular a door rack. In particular, this additional element can be a receiving structure, which is in particular a holding lug 11. In FIG. 2, two holding lugs 11 and 12 are molded onto this boundary wall or side wall 10 by way of example.

FIG. 3 shows a partial view of the inner lining 6 according to FIG. 2. Here, the view shows the elongate bar 8 formed as a hollow body. This bar 8 comprises a side wall 10 facing the opposite bar 9 and a further, separate side wall 13.

As can be identified in a sectional view along the line of intersection IV-IV in FIG. 3, in the view in FIG. 4, these side walls 10 and 13 are oriented relative to one another so that they bound a hollow region 14 of the bar 8 formed as a hollow body. Both side walls 10 and 13 are produced with a wall thickness d of less than 1.5 mm, in particular between 0.6 mm and 1 mm, by the combined injection molding process with thin-wall injection molding and cascade injection molding.

As a result of the combined injection molding process, it is not only possible that such thin-walled structures, in particular with such complex-shaped and hollow partial regions of the household appliance component can be provided, but this molded structure in the form of the hollow body can also be designed with a very narrow width. For example, it is provided with the embodiment shown here that the combined injection molding process also enables a distance a1 measured between a free end 15 of the first side wall 10 and a free end 16 of the second side wall 13 to be smaller than or equal to 14 mm, in particular between 11 mm and 14 mm. The free end 15 of the first side wall 10 opens onto the trough base 7, while the free end 16 of the outer side wall 13 opens onto a side flange 17 of the trough shape.

The two side walls 10 and 13 of this hollow shape of the hollow body open at opposite ends to these free ends 15 and 16 onto a base wall 18 further bounding the hollow body. The base wall 18 closes the groove shape. The combined injection molding process enables a distance a2 between these side walls 10 and 13 at this opening onto the base wall 18 and hence so-to-speak also a corresponding extension of the base wall 18 between these two side walls 10 and 13 can be produced smaller than or equal to 7 mm, in particular between 5 mm and 6.5 mm. A further distance a3 measured between a free end 15, 16 of a side wall 10, 13 and an end of a side wall 10, 13 opening onto base wall 18 is here preferably smaller than 40 mm and greater than 30 mm, in particular between 35 mm and 40 mm. Hence, such an embodiment enables a very narrow hollow bar 8 to be formed. In particular, here the ratio between the bar width, and hence in particular the distance a2, to the bar height, and hence in particular distance a3, is greater than 1:4. Such narrow hollow structures with the wall thicknesses named as preferable can in particular only be produced by this combined injection molding process, as mentioned above.

As can also be identified in FIG. 3 and plotted in FIG. 4, a radius r1 between an outer side of the side wall 10, which is hence facing away from the hollow region 14, and an outer side of the trough base 7 facing the elongate bar 8 is smaller than or equal to 1.5 mm, in particular between 1 mm and 1.5 mm. Hence, such a transition 19 between the side wall 10 and the trough base 7 is produced with a very small radius, which is in particular only enabled by this combined injection molding process. It can also be identified that, at a further transition 20 formed between outer sides of the base wall 18 and the side wall 10, and also in particular between the base wall 18 and the side wall 13, a further very small radius r2 is created, which is produced smaller than 2.5 mm, in particular between 1.5 mm and 2.5 mm, preferably between 1.8 mm and 2.2 mm.

As can be identified in FIG. 1 to FIG. 3, bar 8 in particular extends in a straight line and comprises a longitudinal axis A. In the direction of this longitudinal axis A, the hollow region 14 is closed at both a first end 21 and a second end 22, wherein here in each case front walls 23 and 24 are formed. The combined injection molding process advantageously also enables a radius r3 formed between a free end of the front wall 23 facing away from the base wall 18 and in particular the flange 17 to be produced smaller than or equal to 1.0 mm, in particular between 0.4 mm and 1.0 mm, preferably between 0.4 mm and 0.6 mm. Here, once again this radius measure relates to the outer sides of the front wall 23 facing away from the hollow region 14 and the outer side of the flange 17. This front wall 23 also has a wall thickness of less than 1.5 mm, in particular between 0.6 mm and 1 mm.

In a further advantageous embodiment, the combined injection molding process creates at least one reinforcing rib 25 in the interior of the hollow body and hence in the hollow region 14 of the bar 8. It can be identified in the perspective sectional view of the bar 8 in FIG. 5 that a plurality of such reinforcing ribs 25 is formed at a distance and parallel to one another in this hollow region 14. The reinforcing ribs 25 also preferably have a wall thickness of less than 1.5 mm, in particular between 0.6 mm and 1 mm.

### LIST OF REFERENCE CHARACTERS

1 Household appliance

2 Housing

2a Inner container

3 Receiving space

4 Door

5 Outer door

6 Inner lining

7 Trough base

8 Bar

9 Bar

10 Side wall

11 Holding lug

12 Holding lug

13 Side wall

14 Hollow region

15 Free end

16 Free end

17 Side flange

18 Base wall

19 Transition

20 Transition

21 First end

22 Second end

23 Front wall

25 Reinforcing rib

A Longitudinal axis

a1,a2,a3 Distance

d Wall thickness

r1,r2,r3 Radius

1-14. (canceled)

15. A method for producing a household appliance component for a household appliance, the method comprising the following steps:
producing the household appliance component from plastic by injection molding carried out at least in some phases as a combined injection molding process including thin-wall injection molding and cascade injection molding; and
forming at least one partial region as a hollow body of the household appliance component produced by the combined injection molding process.

16. The method according to claim 15, which further comprises carrying out the thin-wall injection molding with a wall-thickness-flow length ratio of greater than 1:200.

17. The method according to claim 15, which further comprises carrying out the thin-wall injection molding with a wall-thickness-flow length ratio between greater than 1:200 and 1:300.

18. The method according to claim 15, which further comprises producing walls bounding the hollow body by the combined injection molding process with thin-wall injection molding and cascade injection molding providing a wall thickness of less than 1.5 mm.

19. The method according to claim 15, which further comprises producing walls bounding the hollow body by the combined injection molding process with thin-wall injection molding and cascade injection molding providing a wall thickness of between 0.6 mm and 1 mm.

20. The method according to claim 15, which further comprises producing the hollow body as an elongate bar.

21. The method according to claim 18, which further comprises producing the hollow body in a bar shape, and producing two of the walls as two side walls of the bar shape of the hollow body having free ends produced by the combined injection molding process with thin-wall injection molding and cascade injection molding being spaced apart by a distance smaller than or equal to 14 mm.

22. The method according to claim 18, which further comprises producing the hollow body in a bar shape, and producing two of the walls as two side walls of the bar shape of the hollow body having free ends produced by the combined injection molding process with thin-wall injection molding and cascade injection molding being spaced apart by a distance of between 11 mm and 14 mm.

23. The method according to claim 18, which further comprises producing the hollow body in a bar shape, and producing two of the walls as two side walls of the bar shape of the hollow body having ends opening onto a base wall with a groove shape by the combined injection molding process with thin-wall injection molding and cascade injection molding providing a spacing distance between the two side walls being smaller than or equal to 7 mm.

24. The method according to claim 18, which further comprises producing the hollow body in a bar shape, and producing two of the walls as two side walls of the bar shape of the hollow body having ends opening onto a base wall with a groove shape by the combined injection molding process with thin-wall injection molding and cascade injection molding providing a spacing distance between the two side walls of between 5 mm and 6.5 mm.

25. The method according to claim 18, which further comprises:
producing one of the walls as a side wall having an outer side and a free end;
producing a further partial region of the household appliance component opening onto the free end and having an outer side; and
producing a transition between the outer side of the side wall and the outer side of the further partial region by the combined injection molding process with thin-wall injection molding and cascade injection molding having a radius smaller than or equal to 1.5 mm,

26. The method according to claim 18, which further comprises:
producing one of the walls as a side wall having an outer side and a free end;
producing a further partial region of the household appliance component opening onto the free end and having an outer side; and
producing a transition between the outer side of the side wall and the outer side of the further partial region by the combined injection molding process with thin-wall injection molding and cascade injection molding having a radius of between 1 mm and 1.5 mm.

27. The method according to claim 18, which further comprises:
producing the walls as a base wall having an outer side and a front wall having an outer side, the front wall being formed in a direction of a longitudinal axis of the hollow body at one end of the hollow body, the front wall opening onto the base wall and the front wall having a free end;
producing a further partial region of the household appliance component opening onto the free end of the front wall and having an outer side; and
producing a transition by the combined injection molding process with thin-wall injection molding and cascade injection molding at least one of:
between the outer side of the front wall and the outer side of the base wall with a radius smaller than or equal to 2.5 mm, or
between the outer side of the front wall and the outer side of the further partial region with a radius smaller than or equal to 1.0 mm.

28. The method according to claim 18, which further comprises:
producing the walls as a base wall having an outer side and a front wall having an outer side, the front wall being formed in a direction of a longitudinal axis of the hollow body at one end of the hollow body, the front wall opening onto the base wall and the front wall having a free end;
producing a further partial region of the household appliance component opening onto the free end of the front wall and having an outer side; and
producing a transition by the combined injection molding process with thin-wall injection molding and cascade injection molding at least one of:
between the outer side of the front wall and the outer side of the base wall with a radius of between 1.5 mm and 2.0 mm, or
between the outer side of the front wall and the outer side of the further partial region with a radius of between 0.4 mm and 1.0 mm.

29. The method according to claim 18, which further comprises producing one of the walls as a side wall having an outer side with a receiving structure or a holding lug facing away from a hollow region of the hollow body and being produced by the combined injection molding process with thin-wall injection molding and cascade injection molding.

30. The method according to claim 18 which further comprises producing at least one reinforcing rib in a hollow region of the hollow body by the combined injection molding process with thin-wall injection molding and cascade injection molding.

31. The method according to claim 15, which further comprises producing the household appliance component with a trough-shape or a trough base as a partial region of the household appliance component including a quadrangular planar region having at least one of a first side length or width of at least 30 cm or a second side length or height of at least 25 cm on which the hollow body is formed in one piece by the combined injection molding process with thin-wall injection molding and cascade injection molding.

32. The method according to claim 15, which further comprises producing the household appliance component in one piece as an inner lining of a door for a household refrigeration appliance by the combined injection molding process with thin-wall injection molding and cascade injection molding.

33. In a household appliance, the improvement comprising:
a household appliance component having at least some combined thin-wall injection molded and cascade injection molded plastic phases; and
at least one partial region formed as a hollow body of the combined injection molded household appliance component.
